(19) United States
(12) Patent Application Publication
(10) Pub. No.: US 2003/0133849 A1
(43) Pub. Date: Jul. 17, 2003

(54) Amonia oxidaion with reduced formation of N2O

(76) Inventors: Volker Schumacher, Frankenthal (DE); Gerhard Siebert, Frankenthal (DE)

Correspondence Address: KEIL & WEINKAUF, 1350 CONNECTICUT AVENUE, N.W., WASHINGTON, DC, 20036, US

(21) Appl. No.: 10/373,829

(22) Filed: Feb. 27, 2003

Related U.S. Application Data
(62) Division of application No. 09/501,607, filed on Feb. 10, 2000.

(30) Foreign Application Priority Data
Feb. 11, 1999 (DE) 19905753.2

(51) Int. Cl. B01J 4/00

(52) U.S. Cl. 422/172; 422/176

(57) ABSTRACT

In a device for distributing an ammonia/air mixture coming from a tube in the catalytic oxidation of ammonia across the cross section of a vessel whose diameter is a multiple of the tube diameter, the inlet tube is provided with a concentrically arranged inner tube and internal fittings for generating rotation are arranged in the annulus between inlet tube and inner tube to prevent formation of N₂O in ammonia oxidation.

The present invention relates to particular devices for preventing the formation of N₂O in the oxidation of ammonia.

In the industrial production of nitric acid by the Ostwald process, ammonia is reacted with oxygen over a noble metal-containing catalyst to form oxides of nitrogen which are subsequently absorbed in water. In the first step, ammonia and air or oxygen are reacted over a noble metal-containing catalyst gauze in a reactor at from 800 to 955° C. The catalyst gauze generally comprises platinum and rhodium as active metals. To achieve uniform flow onto the catalyst gauze, use is made of various internal fittings such as perforated plates, flow straighteners or other distributors, cf. Ullmann's Encyclopedia of Industrial Chemistry 5^{th} Ed., Vol. A 17, 308 (1991). Such distributors are described, for example, in EP-A 0 044 973. In the catalytic reaction, ammonia is first oxidized to nitrogen monoxide which is subsequently further oxidized by oxygen to form nitrogen dioxide or dinitrogen tetroxide. The gas mixture obtained is, after cooling, passed to an absorption tower in which nitrogen dioxide is absorbed in water and converted into nitric acid. The reactor for the catalytic combustion of ammonia also contains downstream of the catalyst gauze, a recovery gauze in order to deposit and thus recover catalyst metals vaporized at the high reaction temperatures. Downstream of the recovery gauze there is located a heat exchanger by means of which the gas mixture obtained is cooled. Absorption is carried out outside the actual reactor in a separate absorption column.

Combustion and absorption can be carried out at the same pressure. It is possible here to work at a mean pressure of from about 230 to 600 kPa or at a high pressure of from about 700 to 1100 kPa. In a process having two pressure stages, the absorption is carried out at a higher pressure than the combustion. In this case, the presssure in the combustion is from about 400 to 600 kPa and the pressure in the absorption is from about 900 to 1400 kPa.

An overview of the Ostwald process may be found, for example, in Ullman's Encyclopedia of Industrial Chemistry, 5^{th} edition, Volume A 17, pages 293 to 339 (1991).

The combustion of ammonia forms not only nitrogen monoxide and nitrogen dioxide or dinitrogen tetroxide but generally also N₂ and N₂O (dinitrogen monoxide) as by-product. In contrast to the other nitrogen oxides formed, N₂O is not absorbed by the water during the absorption process. If no further step for removing N₂O is provided, the latter can be discharged into the environment in a concentration of from about 500 to 3000 ppm in the waste gas.

Since N₂O is a greenhouse gas and participates in depletion of the ozone layer, removing it as completely as possible from the waste gas is desirable. A number of methods of removing N₂O from waste gas streams have been described.

The removal of N₂O from waste gas streams has the disadvantage that the nitrogen present in the N₂O is frequently lost due to the subsequent work-up. In addition, an undesired N₂O stream is passed through the absorption column so that the desired gas mixture is diluted. It would be advantageous to suppress the formation of N₂O to a substantial extent in the ammonia oxidation, so that the proportion of desired product rises and no by-product gas has to be passed through the apparatuses.

It is an object of the present invention to prevent the formation of N₂O in ammonia oxidation.

We have found that this object is achieved by a device for distributing an ammonia/air mixture coming from a tube in the catalytic oxidation of ammonia across the cross section of a vessel whose diameter is a multiple of the tube diameter, wherein the inlet tube is provided with a concentrically arranged inner tube and internal fittings for generating rotation are arranged in the annulus between inlet tube and inner tube to prevent formation of N₂O in ammonia oxidation. Such devices are known, for example, from EP-A 0 044 973.

The ammonia/air mixture generally comes from a tube via a cap into a cylindrical reactor section in whose upper end the platinum gauzes are installed across the entire cross section of the vessel. The cap comprises a widening section, for example cones or domed ends, and a cylindrical transition section.

It is known that uniform flow onto the gauze pack is necessary for a good yield. It has now been found that passing the ammonia/air mixture through the device configured according to the present invention leads to prevention of formation of N₂O in ammonia oxidation.

It has been found that a considerable part of the N₂O is formed not just during the reaction of ammonia and air in the platinum gauzes but even beforehand on hot surfaces upstream of the platinum gauze, particularly on the surface of internal fittings if these are heated to temperatures in the range from 300 to 500° C. by the radiative heat from the glowing platinum gauzes and thus act as catalytic surfaces to oxidize some of the ammonia to N₂O.

An illustrative embodiment of the invention is described below with the aid of the drawing:

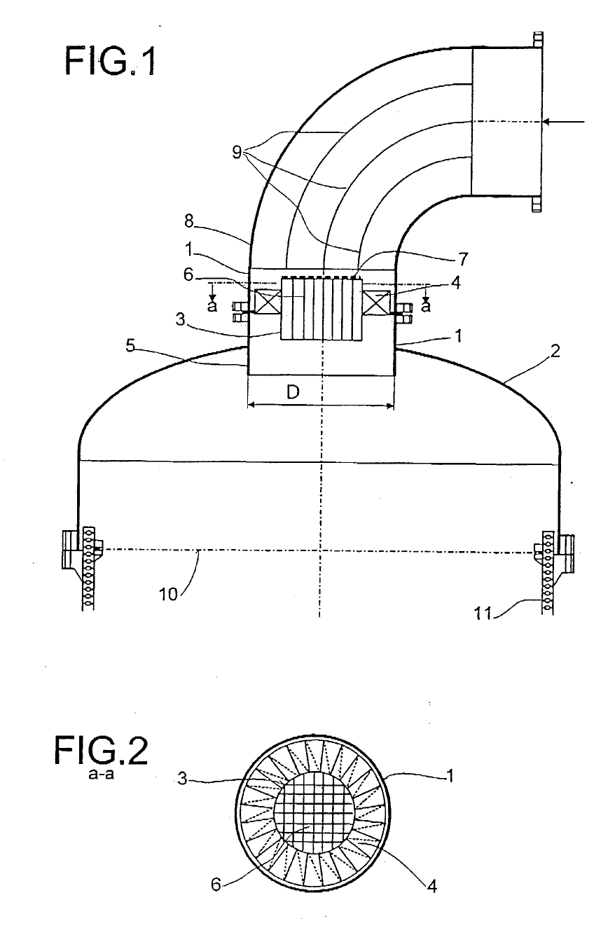

FIG. 1 schematically shows an axial longitudinal section of the upper part of an ammonia combustion furnace in which the flow distributor used according to the present invention is installed, and

FIG. 2 shows a cross section with a plan view of a flow distributor at the point denoted by the line a-a in FIG. 1

The gas stream enters the cap 2 in a customary fashion via a pipe bend 8 provided with guide plates 9, and a short straight inlet tube 1 and subsequently enters the cylindrical reactor section. The Pt gauzes 10 are installed at the end of the cap. After the reaction over the Pt gauzes, the hot gases enter the heat recovery section 11 which is joined to the cap by means of a pair of flanges and is used to protect the outer wall of the vessel from heat; only the upper end of the heat recovery section 11 with the beginning of the tubes around the wall is shown in FIG. 1.

The concept of the novel flow distributor comprises exercising a certain degree of remote control over the flow to the gauze by means of internal fittings only in the cold inlet tube 1. For this purpose, the flow in the inlet tube is divided by means of a concentric inner tube 3 and the outer stream is provided with a rotational impulse by means of internal fittings 4. The combination of the rotating outer stream with axial core flow has the effect that the flow is stable along the cap wall without a backflow region to the reactor axis being formed.

It has been found to be advantageous to place a ring of guide vanes 4 in the annulus between inlet tube and inner tube in order to impart rotation to the outer stream.

The pitch of the guide vanes relative to the inflow direction should be from 30 to 55° depending on the opening angle of the flow. In order to avoid lopsided flow onto the cap wall with backflow to the opposite side of the cap, it is advantageous for the inlet tube to project into the vessel so as to form a separation edge 5. Instead of aligning the core flow axially with the honeycomb bundle running in the axial direction, it can alternatively be stabilized by providing it with a slight rotation. The guide vanes to be used for this purpose in the core tube instead of the flow alignment honeycombs must then have pitch of not more than 15° in order to avoid backflow to the reactor axis. To balance the ratio of the gas flows in the inner tube and in the annulus, it is necessary to fit a flow resistance, for example a screen, at the inlet end of the inner tube.

In a further advantageous embodiment of the invention, a ratio of the diameters of inner tube to inlet tube of from 0.4 to 0.7 is selected. The distance from the end of the inner tube to the end of the inlet tube should be from 0.1 to 0.5 times the inlet tube diameter. This effects intermeshing of core and outer flows before entry into the cap.

In the catalytic oxidation of ammonia, the advantages of the installation of the flow distributor used according to the present invention are that the yield is increased as the formation of N₂O is decreased as a result of the uniform and backflow-free distribution of the reaction gas over the platinum gauzes. A further advantage is that omission of internal fittings in the cap section and elimination of backflow avoids production problems due to flashback.

The invention is illustrated by the following examples.

### EXAMPLE 1

### Comparison

An industrial oxidation reactor having a gauze diameter of 3 meters is operated at atmospheric pressure and a gauze temperature of 890° C. with a throughput of 100 kg/h of ammonia/m² of gauze area in a gas stream of 8000 standard m³/h. The ammonia-containing gases flow in through a feed tube having a diameter of 8.2 m which is widened by means of a cone having a height of 1.1 m to the gauze diameter of 3 m. To provide uniform distribution of the gas, 2 perforated plates each having 7500 holes of 8 mm diameter each are installed 700 mm above the platinum gauzes. In an oxidation reaction of ammonia, the main product NO is formed in a yield of about 97%; the by-product N₂O is present in the outflowing gas stream in a concentration of from 800 to 1000 ppm/v.

### EXAMPLE 2

### According to the Present Invention

The perforated plates used for uniformly distributing the gases were removed from the oxidation reactor described in Example 1 and the inflow tube was fitted, just upstream of the widening of the cone, with the device used according to the present invention for uniformly distributing the gases.

Under the same operating conditions as in Example 1, an N₂O content of from 500 to 600 ppm/v is found in the outflowing gas.

We claim:

1. Device for distributing an ammonia/air mixture coming from a tube in the catalytic oxidation of ammonia across the cross section of a vessel whose diameter is a multiple of the tube diameter, wherein the inlet tube is provided with a concentrically arranged inner tube and internal fittings for generating rotation are arranged in the annulus between inlet tube and inner tube to prevent formation of N₂O in ammonia oxidation.

2. Device as claimed in claim 1, wherein the internal fittings installed in the annulus between inlet tube and inner tube in the device are a ring of guide vanes.

3. Device as claimed in claim 1, wherein the pitch of the guide vanes relative to the flow direction in the device is from 30 to 55°.

4. Device as claimed in claim 1, wherein the inlet tube in the device projects into the vessel to form a separation edge.

5. Device as claimed in claim 1, wherein the concentrically arranged inner tube in the device is provided with a honeycomb bundle running in the axial direction or guide vanes whose pitch is not more than 15°.

6. Device as claimed in claim 1, wherein a flow resistance is fitted at the outlet end of the inner tube in the device.

7. Device as claimed in claim 6, wherein the flow resistance is fitted in the form of a screen.

8. Device as claimed in claim 1, wherein the ratio of the diameters of inner tube to inlet tube in the device is from 0.4 to 0.7.

9. Device as claimed in claim 1, wherein the distance from the end of the inner tube to the end of the inlet tube in the device is, viewed in the flow direction, from 0.1 to 0.5 times the inlet tube diameter.
